(19) United States
(12) Patent Application Publication
(10) Pub. No.: US 2008/0007378 A1
(43) Pub. Date: Jan. 10, 2008

(54) Toroidal Core Transformer

(76) Inventor: Volker Werner Hanser, Kehl (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/576,171

(22) PCT Filed: Oct. 6, 2005
(86) PCT No.: PCT/EP05/10783

§ 371 Date: Mar. 28, 2007

(30) Foreign Application Priority Data
Oct. 7, 2004 (DE) 102004048793.6
Mar. 9, 2005 (DE) 102005041975.5

(51) Int. Cl. H01F 30/12; H01F 27/08; H01F 30/16; H01F 7/06

(52) U.S. Cl. 336/5; 29/602.1; 29/605

(57) ABSTRACT

A polyphase transformer (101) having a number of toroidap cores (102) arranged adjacent to one another in an axial direction is provided. The toroidal cores (102) support phase windings of different phases. The connecting points pf the phase windings of tow adjacent toroidal cores (102) are offset from one another in a peripheral direction. This offset, i.e., the geometric angle between the connecting points of the phase windings of the two adjacent toroidal cores (102), approximately corresponds to a phase shift, i.e., to the electric phase angle between the voltage signals of the toroidal cores (102).

### BACKGROUND

The invention relates to a toroidal-core transformer, in particular, to a polyphase transformer comprising several toroidal cores adjacently arranged in the axial direction, with adjacent toroidal cores carrying phase windings of different phases. For polyphase transformers comprising toroidal-core windings arranged adjacently there is the problem that there are high voltage differences between the individual phase windings and complicated insulating measures are necessary accordingly, in order to prevent arc-overs due to dripping water or condensation or the formation of ice and in order to guarantee the operating reliability of the polyphase transformer. If necessary, it is also required to provide heating at the polyphase transformer, in order to prevent, for example, arc-overs between the individual phase windings due to the formation of ice.

The insulating measures are very cost-intensive. In addition, the insulating measures require a certain overall size of the polyphase transformer, which increases its space requirements.

From the European Patent DE 691 10273 T2, a three-phase toroidal-core transformer is known, whose toroidal cores are arranged adjacent to each other in the axial direction and each carry different phases. This toroidal-core transformer is provided for operation at low voltage. For use in the medium-voltage range, high potential differences and thus arc-overs would be produced both in the area of the connections and also the windings themselves.

### SUMMARY

On the other hand, there is the objective of creating a toroidal-core transformer of the type named above, which requires only reduced insulating measures and whose overall size is reduced. In addition, for a smaller overall size, a high power density should be possible.

This objective is met according to the invention in that the connection points of the phase windings of two adjacent toroidal cores are offset from each other in the peripheral direction. The electrical phase shift between the individual phase windings of the polyphase transformer is practically eliminated or reduced through a mechanical offset of the phase windings. Therefore, the potential difference between adjacent winding sections of different phases is reduced, so that also less complicated insulating measures are required accordingly for insulating adjacent phase windings from each other and thus the costs for the insulating measures are likewise reduced. Due to the low potential differences between the phase windings of adjacent toroidal cores, these can also be arranged at a small distance from each other, whereby the overall size for the polyphase transformer is reduced.

An especially preferred embodiment provides that the offset or the geometric angle between the connection points of the phase windings of two adjacent toroidal cores corresponds to the phase shift or the electrical phase angle between the voltage signals of these toroidal cores. There is then practically no longer any potential difference between directly adjacent winding sections of two toroidal cores. For a three-phase system, the connection points of the three phase windings are each offset by 1200 relative to each other, in order to mechanically compensate for the phase angle between the individual phases.

Because a spacer is provided between the individual toroidal cores, typically for mechanical stabilization and mounting, it is possible to allow small potential differences between two adjacent phase windings, so that a mechanical rotation of the toroidal cores that is reduced relative to the electrical phase shift is sufficient for preventing voltage arc-overs between the phase windings even for reduced or completely eliminated insulating measures. The requirements on precision for the production of the polyphase transformer are reduced in this way, which simplifies production.

One embodiment according to the invention for the toroidal-core transformer of independent significance provides that a preferably essentially cylindrical housing adapted to the structural shape of the toroidal-core transformers is provided for the toroidal cores with phase windings, and that preferably a fan or a similar blower is provided at one axial end of the housing. The toroidal cores with the phase windings are arranged in the housing protected from contamination and damage. With the fan, the arrangement is cooled, in order to prevent thermal overload of the polyphase transformer.

The housing with the provided cooling measures promotes a compact construction of the transformer for a higher power density. Especially for a polyphase transformer according to claim 1 or claim 2, this has an advantageous effect, because these measures also lead to a compact construction that makes the corresponding cooling measures necessary.

To cool the polyphase transformer it is also possible that hollow lines for a coolant are arranged in the area of the toroidal cores and that the housing of the transformer is preferably constructed as a heat exchanger and connected to the hollow lines. The housing can have a two-wall construction, in order to dissipate the heat particularly well to the outside. The coolant can be pumped through the hollow lines and the housing with a pump.

An especially favorable embodiment provides that cooling bodies or similar projecting elements for increasing the housing surface area are provided on the outside on the housing or that the housing has a profiled surface. Through the increased surface area, the heat is better dissipated and thermal overloads can be avoided.

It is also possible to cast the transformer coils individually with casting resin, with a housing for each coil being formed by the casting resin. Here, a casting mold shaped complementary to the desired cooling bodies or cooling ribs can be provided, in order to obtain the desired outer contours with projecting elements for increasing the surface area directly from the casting of the coils. By casting the coils, on one hand a mechanical stabilization of the phase winding and also a direct thermal coupling between the winding and the housing formed by the casting resin is achieved. In addition, a high electric resistance is achieved with the casting.

An initially smooth surface of the housing can also be increased by roughening, structuring, or profiling the surface through a suitable method, for example, etching or sandblasting.

Preferably, the surface has a structure, with which the heat can be better dissipated. It should also be mentioned that the spacing and insulating elements could be cast at the same time as the casting of the transformer coils.

Another possibility for cooling the toroidal-core transformer is provided in that a receptacle container is provided with a coolant for the insertion of some or all areas of the transformer.

An especially advantageous embodiment provides that the toroidal cores of the polyphase transformer have a modular construction with their corresponding phase windings and that a holding device is provided for holding and for mutually fixing the modular toroidal cores. Several modules can be interconnected such that the power of the transformer can be increased. In this way, transformers with powers greater than 100 MVA can be realized. In addition, it is possible through the modular construction for the transformer to continue to operate if one of the modules fails, in that a replacement module is connected, if necessary, temporarily and thus the entire transformer remains ready for operation. Thus it is not necessary to keep ready an entire reserve transformer, which can be switched to in the case of a defect. Therefore, costs are saved and the space requirements for a reserve module are small in comparison with the space requirements for an entire reserve transformer.

The individual modules are held and fixed in their position relative to each other with a holding device. Insulating elements for insulating the phase windings, especially from the outside, can also be provided on the holding device. In the axial direction, only holding or support elements need to be provided as supports for the toroidal cores between adjacent toroidal cores or their phase windings, in order to hold the toroidal cores in their position and to prevent the toroidal cores from becoming off center. Special insulating measures are unnecessary here due to the mechanical rotation of the connection points of the phase windings according to the electrical phase position in the corresponding phase windings and the resulting previously described advantages.

The invention also relates to a high-voltage winding of a toroidal-core transformer, as well as to its production process, for distribution transformers for powers greater than 100 kVA and voltages greater than 6000 V on the basis of toroidal-core technology.

The winding of high-power and high-voltage toroidal-core distribution transformers, for example, 2000 kVA and 20,000 V, is very complicated, time intensive, and thus expensive. The high-voltage winding must be divided into several segments, so that the layer voltage of the high-voltage winding can be reduced and operational safety can be guaranteed. At a voltage of 20,000 V, for example, 10 segments are provided. Here, the voltage per segment equals 2000 V. The layer voltage is therefore reduced to a tenth. Furthermore, the electric resistance relative to the low-voltage winding is ensured.

Therefore, winding devices have already been developed, with which the winding of such transformer windings is simplified. In EP 94 930 197.2, for example, a winding device is described, in which the small winding rollers with winding material are moved through a toroidal core along a guide surrounding the toroidal core and in this way winding material is rewound onto the toroidal core. This device, however, is very complicated and electric strength can be realized only with limitations. In addition, it is necessary to first wind winding material onto the small winding rollers that can pass through the toroidal core, which also requires additional time. In addition, it is only possible to place one winding onto each toroidal core at one time. For larger toroidal cores with a plurality of windings (segments) arranged one next to the other, a lot of time is required for wrapping all of the transformer windings.

Therefore, in particular there is the objective of creating a winding device and a load-stable high-voltage winding of the type named above, in which the wrapping is simplified and accelerated and with which the necessary electric strength relative to the low-voltage winding of the transformer can be realized.

This objective is met according to the invention in that, in particular, at least one winding station is provided with a winding carrier comprising two load-stable half shells with side flanges (at least one side flange with an insulated hollow space for the passage of the line material) made from insulating material of high strength, which are joined into a load-stable round unit around the closed toroidal core, or the winding carrier is produced as a whole by a casting mold around the toroidal core in a pressure-gelling method, for accommodating the segments of the high-voltage winding of the transformer, comprising at least one electrical conductor and at least one insulating material with a holding and rotating support attached to the winding carrier for the rotating support of the winding carrier. The holding and rotating support has several rollers or similar cylindrical bodies, which attach to the winding carrier at the peripheral side and of which at least one is connected to the driving and braking device, in order to drive and brake the winding carrier, so that the electrical conductor and the insulating material can be wound onto a closed toroidal core.

Thus it is possible to wind onto a load-stable winding carrier made from insulating material, which surrounds a closed toroidal core and is rotated about the toroidal-core cross section. Through the use of the load-stable winding carrier, the other insulating measures can be reduced significantly. Furthermore, it is not necessary to first divide the toroidal core into two halves in order to push on the windings. The production of a toroidal-core distribution transformer and the application of the physical advantages, especially the significantly higher efficiency and the reduced operating costs of a closed toroidal core, are therefore significantly simplified.

The winding carrier preferably is formed of two high-strength half shells with side flanges, which are equipped with an overlapping latching device or a hinge and an overlapping latching device, which are joined, preferably with a special adhesive, fixed around the closed toroidal core before the actual winding process to form a round unit, so that the strength relative to the low-voltage winding can be guaranteed. Another embodiment of the winding carrier provides that a separable casting mold is placed around the closed toroidal core, with whose help the winding carrier, for example, can be produced directly on the closed toroidal core in a pressure-gelling method and can be positioned and wrapped in one piece around the toroidal core after removing the casting mold. The winding carrier has a hollow space that is insulated relative to the winding space in at least one side flange, wherein an opening in the winding space of the winding carrier is located at the bottom end of the hollow space, for passing the lower start of the winding upwards laterally past the winding. This winding carrier has six advantageous functions: first, guaranteeing the basic electric strength relative to the low voltage; second, holding the high-voltage winding; third, allowing the winding process; fourth, allowing the spacing of the segments relative to each other through spacers; fifth, realizing a given distance to the low-voltage winding; and sixth, allowing the insulation of the bottom start of the winding through a hollow space insulated from the winding in the winding carrier with the smallest space at the top. For the various fields of use of toroidal-core distribution transformers and for guaranteeing the electric strength, the winding carrier with the segments of the high-voltage winding can be filled with one or more insulating materials. For example, it can be filled with a casting resin under atmospheric conditions, casting resin filler under a vacuum, casting resin filter through a pressure-gelling method or for a tight construction with gaseous or liquid insulating materials, for example, nitrogen or a suitable oil. If necessary, the winding carrier can be constructed with a cover for insulation, for tightness, or for protection against damage. Another embodiment provides that the winding carrier can have a construction that is electrically conductive on the outside, under consideration that no closed winding is created around the toroidal core itself. This electrically conductive layer can be grounded if necessary or can be set to a defined potential.

For wrapping a winding carrier, this is inserted into the holding and rotating support of the winding device, and the winding material is fed to the winding carrier from the winding material storage roller(s) at a distance from the holding and rotating support. With the driving and braking device, at least one of the roller bodies is driven or braked and rotated, whereby the winding carrier, to which this roller body attaches peripherally, is set in rotation. Roller bodies not connected to the drive device are here used as holders for the winding carrier. For preventing frictional forces, these are preferably also rotatably supported, so that rolling or turning of the winding carrier on these roller bodies is possible. It is advantageous if a frictionally engaged, optionally positive-fit driving and braking device is provided between the winding carrier and at least the roller body(ies) connected to the driving and braking device. A frictionally engaged connection can be realized in a structurally simple way. It is also possible, however, to provide a positive-fit connection, for example, by forming teeth on the roller body and the side flange of the winding carrier.

By rotating the winding carrier, the winding material is unwound from the winding material storage roller(s) and wound onto the winding carrier. Because the winding material storage roller(s) are fixed in place and cannot be moved around the winding carrier, large winding material storage rollers can be used, on which winding material can be deposited for wrapping several winding carriers one after the other. Windings for high-power toroidal-core distribution transformers, for example, greater than 10 MVA, can be wrapped. Both round wires and also flat cables can be used as the winding material.

An especially favorable embodiment provides that several winding stations arranged one next to the other in the peripheral direction are provided for the simultaneous wrapping of several winding carriers arranged, in particular, on a toroidal core. In this way, several winding carriers arranged one next to the other can be wrapped in groups or all at the same time, whereby the time required for wrapping can be significantly reduced. The number of winding stations can be selected so that there is one winding station for each winding carrier. In this way, the winding carriers can be wrapped in groups or all at the same time. The control is realized centrally. In this construction, the winding device is preferably divided into two tiers, with the winding material storage roller(s) being arranged in the upper tier of the winding device. Therefore, the controllability is significantly simplified. The tiers can also be reversed if necessary.

It is preferable when at least one first winding material storage roller is provided with conductive material and at least one second winding material storage roller is provided with insulating material for the simultaneous layered winding of conductive material and insulating material on the winding carrier. It is also possible to provide three, four, or five winding material storage rollers for the simultaneous wrapping of a winding carrier, with two, three, or four winding material storage rollers carrying conductive material and a third, fourth, or fifth winding material storage roller carrying insulating material for insulation. If insulated conductive material is used, one winding material storage roller is sufficient.

A preferred embodiment provides that the roller bodies are spring mounted and preferably also damped for adapting to the winding carrier, which can be different in diameter and/or in outline. In this way it is possible to wrap winding carriers with circular cross sections and different diameters with a winding station without structurally changing the winding station or the holding and rotating support. For this purpose, the roller support can be positioned at a distance against the spring force more or less according to the winding carrier diameter. In addition, it is possible to also wrap winding carriers with a non-round, for example, oval cross section. Due to the spring-mounted support, the roller bodies always contact the winding carrier even for a winding carrier with a non-round cross section, whereby, on one hand, the holder and, on the other hand, the rotary drive of the winding carrier are guaranteed. It is preferable when a rotary support is provided with a driving and braking device for each winding material storage roller, so that a defined winding tension can be maintained.

With the winding carrier according to the invention for the high-voltage winding of a toroidal-core distribution transformer, the electric strength can be realized and with the winding device it is possible to wrap the high-voltage windings for a toroidal-core distribution transformer in a relatively short time.

The invention provides a transformer, in particular, the high-voltage winding of a high-power toroidal-core transformer, and also its production method, wherein at least winding station is provided with a winding carrier comprising two load-stable half shells with side flanges made from insulating material of high strength, which are joined into a load-stable round unit around the closed toroidal core, for accommodating the segments of the high-voltage winding of the transformer, made from an electrical conductor and an insulating material with a holding and rotating support attached to the winding carrier for rotatable support of the winding carrier. The holding and rotating support has several rollers or similar roller bodies, which attach peripherally to the winding carrier and of which at least one is connected to the driving and braking device, in order to drive and brake the winding carrier, so that the electrical conductor can be wound with the insulating material onto a closed toroidal core.

In another embodiment, there is a transformer, in particular the high-voltage winding of a high-power toroidal-core transformer, as well as its production method, wherein the winding carrier is filled with solid, liquid, or gaseous insulating material after or during the placement of the high-voltage winding.

In another embodiment, a transformer is provided, wherein at least one side flange of a winding carrier is equipped with an insulated hollow space, wherein at the bottom end of the hollow space there is an opening in the winding space of the winding carrier for the passage of the lower start of the winding of the conductive material of the high-voltage winding towards the top.

In another embodiment, a transformer is provided, wherein a separable casting mold is placed around the closed toroidal core, with whose help the winding carrier can be produced directly on the closed toroidal core, for example, in a pressure-gelling method and can be positioned in one piece and wrapped around the toroidal core after removing the casting mold.

In another embodiment, a transformer is provided, wherein the winding carrier is comprised of at least two parts with side flanges, which are equipped with at least one overlapping latching device or a hinge and an overlapping latching device, which are joined to form a round unit, preferably with a special load-stable adhesive, around the closed toroidal core before the actual winding process.

In another embodiment, a transformer is provided, wherein the winding carrier comprises several insulating materials and wherein the winding carrier has holders for the high-voltage winding and wherein the side flanges of the winding carrier have a frictionally engaged or positive-fit surface, and wherein the winding carrier has spacers for setting a defined spacing of the segments relative to each other, and wherein the winding carrier has holders for setting a defined spacing to the low-voltage winding.

In another embodiment, a transformer is provided, wherein the winding carrier is filled with a casting resin under atmospheric conditions, casting resin filler under a vacuum, casting resin filler through a pressure-gelling method, or in a sealed construction with gaseous or liquid insulating materials, for example, nitrogen or an insulating oil, during or after the winding process.

In another embodiment, a transformer is provided, wherein the winding carrier can have an electrically conductive construction on the outside, under the consideration that no closed winding is produced around the toroidal core itself. This electrically conductive layer can be grounded or can be set at a defined potential.

In another embodiment, a transformer is provided, wherein several winding stations arranged one next to the other in the peripheral direction are provided for the simultaneous wrapping of several winding carriers, in particular arranged on a toroidal core.

In another embodiment, a transformer is provided, wherein the winding device is divided into two tiers, wherein the winding material storage roller(s) are arranged in the upper tier of the winding device or the reverse.

In another embodiment, a transformer is provided, wherein at least one first winding material storage roller is provided with conductive material and at least one second winding material storage roller is provided with insulating material for the simultaneous, layered winding of conductive material and insulating material on the winding carrier or three, four, or five of the winding material storage rollers are provided for the simultaneous wrapping of a winding carrier, wherein two, three, or four of the winding material storage rollers carry conductive material and a third, fourth, or fifth winding material storage roller carries insulating material for insulation.

In another embodiment, a transformer is provided, wherein the cylindrical bodies are spring mounted and preferably also damped for adapting to winding carriers that are different in diameter and/or outline.

The invention also relates to the low-voltage winding of a toroidal-core distribution transformer and also to its production method, a closed multiple-stage transformer core of high stability, electrically insulated from the outside, and also to its production method, for distribution transformers in casting resin technology with powers greater than 100 kVA and voltages greater than 6000 V on the basis of toroidal-core technology.

Low-voltage windings for distribution transformers have very large cross sections, for example, ca. 1500 mm² for 1000 kVA. Such cross sections are produced for conventional distribution transformers with leg-shaped constructions with wide electrically conductive bands. Such bands cannot be used for a toroidal-core distribution transformer due to the geometric relationships. Previously, low-voltage windings had to be produced in very complicated form by connecting electrically insulated flat wires in parallel. Toroidal cores for toroidal-core transformers are today produced only for small powers and low voltages in one-stage form. Multiple-stage closed toroidal-core transformer cores of high strength and insulated from the outside and their production methods are unknown for distribution transformers.

There is the objective of placing a low-voltage winding with an electrical conductor of large cross section around a closed toroidal core, so that a high-power toroidal-core distribution transformer (greater than 100 kVA up to the megawatt range) is realized. Another objective consists in realizing a multiple-stage closed toroidal core of high strength, which has a construction electrically insulated from the outside, as well as a production method that is economical for this toroidal core.

The high strength of the toroidal cores with a weight from 100 kg up to greater than 2000 kg is necessary so that the thin transformer plates remain dimensionally stable, first for further processing and also in later continuous operation. The electric insulation is necessary so that the transformer winding has sufficient electric resistance relative to the core.

There is the objective of attaching a low-voltage winding with an electric conductor of large cross section around a closed toroidal core and creating a closed multiple-stage toroidal-core transformer core of high strength, which is electrically insulated on the outside, and creating an economical automated production method for this transformer core, so that the production of toroidal-core distribution transformers is allowed.

The solution according to the invention for meeting this objective is provided in that a winding of the low-voltage winding is preformed from an electrically conductive material in two halves, these two halves are connected to each other electrically around the closed toroidal core, wherein at least one half has one tier, so that a spiral winding is produced comprising several windings on the closed toroidal core for the toroidal core, a thin magnetically conductive material is wound to form a multiple-stage closed toroidal-core transformer core, and an adhesive, which mutually insulates the material (for preventing eddy currents) and which fixes the toroidal core, between the magnetically conductive material and the electric insulation relative to the low-voltage winding is provided with spacer rings or spacers made from electrically non-conductive material. For increasing the strength and for electrical insulation from the outside, the toroidal-core transformer core can be completely cast with an electrically non-conductive casting resin of high strength.

Another embodiment provides that the electrical insulation (core relative to the low-voltage winding) is realized through at least three spacer rings or three spacers per winding, which are fixed in the stages of the toroidal core. Then the toroidal core is coated with a coating for insulation and for protection against corrosion.

For the solution of the toroidal-core winding method, a carrier holder for holding the devices requires for each width of the magnetically conductive material at least one storage roller device, one driving and braking device, with a guide device, a cutting device, and an adhesive spraying device, for each width of the magnetically conductive material of at least one winding device with a driving and braking device, as well as a common guide rail.

The winding process begins narrow, then goes wide, and back to narrow. The winding height is monitored by a remote sensing device. When the desired value is reached, the winding process for the corresponding width ends, the magnetically conductive material separates, and the next width is fed onto the guide rail. During the winding process, the magnetically conductive material is sprayed with adhesive. In this way, a closed multiple-stage toroidal core, which has adhesive for insulating the magnetically conductive material and has sufficient strength for further processing, is produced. For each width of the magnetically conductive material, with the exception of the widest material, two storage rollers including all devices and two winding devices including all devices according to the number of stages of the toroidal core must be provided. In steady state operation, all of the storage roller units and also all of the winding units are in operation simultaneously.

A winding of the low-voltage winding is preformed from two halves with electrically conductive material, for example, from aluminum with a cross section of 1500 mm². At least one half has one tier so that one winding is produced from the individual halves and a continuous spiral winding is produced from the windings, wherein the shape of the tier defines the spacing for insulating the windings from each other. The individual halves can be screwed and/or welded together.

Therefore, it is possible to realize a low-voltage winding with any size cross section in a relatively short time.

The advantage of the toroidal-core technology is provided in that toroidal-core distribution transformers up to the highest power range can be realized, which are extremely low loss and feature only ca. 50% of the operating costs of conventional distribution transformers in casting resin technology. Therefore, the toroidal-core distribution transformer pays for itself in a few years and a significant portion of primary energy can also be saved for preserving resources and the environment.

With the toroidal-core winding device described above, an economical production of toroidal-core transformers is achieved, such that, for example, for eleven stages, eleven toroidal-core transformer cores can be wound simultaneously.

The objective is also met by a transformer, especially a spiral low-voltage winding of large cross section and its production, a multiple-stage closed toroidal-core transformer core of high stability, made from magnetically conductive and mutually insulated material, electrically insulated relative to the low-voltage winding, and also its production method, wherein preferably a carrier holder is provided with at least 3 storage roller devices each with a braking device, with at least 2 different widths of magnetically conductive material, at least three adhesive spraying devices, and also at least three winding devices with a drive system, at least three guide devices, a guide rail, and also a cutting device.

In one preferred embodiment, a transformer is provided, wherein each storage roller device and also each winding device is equipped with a driving and braking device.

In one preferred embodiment, a transformer is provided, wherein for each width of the magnetically conductive material with the exception of the widest material, two winding devices are each provided with a driving and braking device.

In one preferred embodiment, a transformer is provided, wherein the magnetic material is pre-treated with an insulating layer.

In one preferred embodiment, a transformer is provided, wherein the closed toroidal-core transformer core is wound in several stages with a thin magnetically conductive material, which is pretreated with adhesive or is sprayed with adhesive during the winding process.

In one preferred embodiment, a transformer is provided, wherein at least three spacing rings or three spacers per winding are fixed in the stages of the toroidal core.

In one preferred embodiment, a transformer is provided, wherein the toroidal core is coated with a coating for insulation and for protection against corrosion.

In one preferred embodiment, a transformer is provided, wherein the toroidal-core transformer core is clad with a high-strength casting resin.

In one preferred embodiment, a transformer is provided, wherein the magnetically conductive material has an amorphous structure.

The objective is also met by a transformer, especially a spiral low-voltage winding of large cross section and its production, a multiple-stage closed toroidal-core transformer core of high stability from magnetically conductive and mutually insulated material, electrically insulated relative to the low-voltage winding, and also its production method, wherein a winding of the low-voltage winding is preformed from an electrically conductive material in two halves, these two halves are connected to each other in an electrically conductive way around the closed toroidal core, wherein at least one half has a tier, so that a spiral winding comprised of several windings on the closed toroidal core is produced.

In one preferred embodiment, a method is provided, wherein the winding halves are screwed and/or welded to each other.

The invention is explained in more detail below with reference to the figures.

### BRIEF DESCRIPTION OF THE DRAWINGS

FIG. 1 is a schematic view of a side section through a polyphase transformer according to the invention with three toroidal cores arranged adjacently in the axial direction.

FIG. 2 is a schematic view of an embodiment of a winding carrier and the winding process according to the present invention.

FIGS. 3a and 3b are views of a five-stage toroidal core according to an embodiment of the present invention.

FIG. 4 shows an arrangement for performing a method according to the invention.

### DETAILED DESCRIPTION OF THE PREFERRED EMBODIMENTS

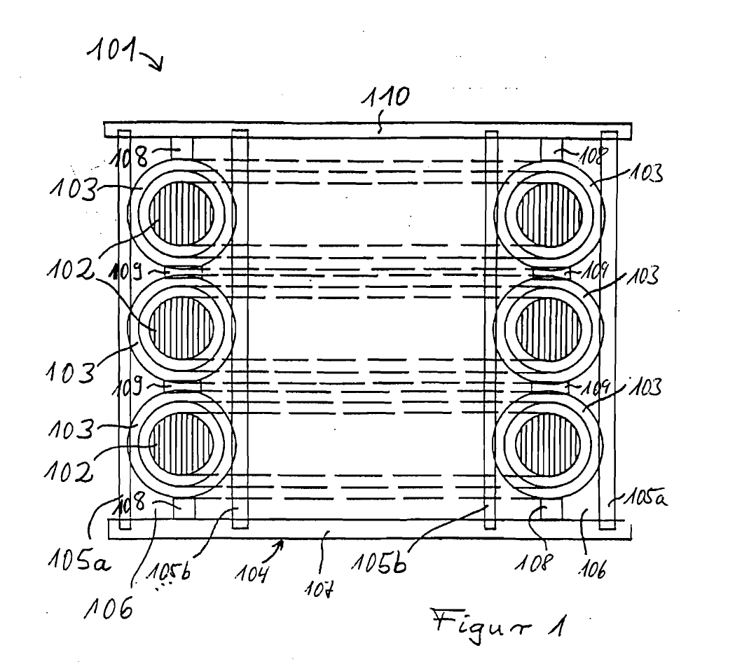

In FIG. 1, a polyphase transformer designated as a whole with 101 is shown, which has three toroidal cores 102 arranged one above the other in the axial direction. Adjacent toroidal cores 102 here carry phase windings of different phases, with the phase windings each being applied on the toroidal cores 102 of ring-shaped surrounding coil bodies 103. Here, coil bodies 103 can be arranged alternately with primary and secondary windings one next to or above the other. It is also possible that primary and secondary windings are applied in common on one coil body 103.

The toroidal cores 102 are arranged in a holding device 104, which has external and also internal guide rails 105a, 105b for forming a receptacle area for the toroidal cores 102. The guide rails 105a, 105b are each composed of insulating material, so that the toroidal cores 102 or the phase windings on the coil body 103 of the toroidal cores 102 are insulated from the outside at the side.

The holding device 104 has on the bottom a base part 107, which is likewise comprised of insulating material. On the base part 107 there are insulating support elements 108 for the lower toroidal core 102. Here, several support elements 108 spaced apart from each other can be provided or a continuous ring is provided as a support element 108. Between the individual toroidal cores 102 there are spacers 109, with which the toroidal cores 102 or the coil bodies 103 allocated to each toroidal core 102 are fixed in their position relative to each other. Above the upper toroidal core 102 there are, in turn, insulating support elements 108, on which a cover part 110 is supported and also insulates the toroidal cores 102 on the top from the outside.

The polyphase transformer 101 shown in FIG. 1 is constructed as a three-phase transformer. The connection points not shown in more detail for the individual phase windings of the toroidal cores 102 or the coil bodies 103 are each offset by 120° from each other. The phase windings are therefore arranged offset mechanically by an angle relative to each other, which corresponds to the electrical phase shift or the electrical phase angle between the voltage signals of these phase windings.

Especially in the area of the spacers 109, that is, where adjacent toroidal cores have the smallest distance from each other, there is practically no potential difference at two opposite areas of two toroidal cores 102 or coil bodies 103. Voltage arc-overs between adjacent toroidal cores 102 are also not possible for toroidal cores 102 arranged closely relative to each other. The polyphase transformer 101 can therefore have a compact construction with reduced space requirements. In addition, between the individual toroidal cores 102, in the area of the spacers 109, no or only minimal insulating measures are necessary, which saves costs and simplifies the construction.

The toroidal cores 102 have a modular construction with each of their coil bodies 103. If there is a defect in one of these modules, the affected toroidal core can be exchanged for a replacement module or the defective module is electrically separated and a replacement module is connected temporarily to the polyphase transformer 101. Thus, it is not necessary to keep ready a complete transformer as a reserve device, but instead it is sufficient to keep ready a toroidal core with the coil bodies carrying the phase windings as a reserve module. Therefore, costs are saved and the space requirements for a reserve device are reduced.

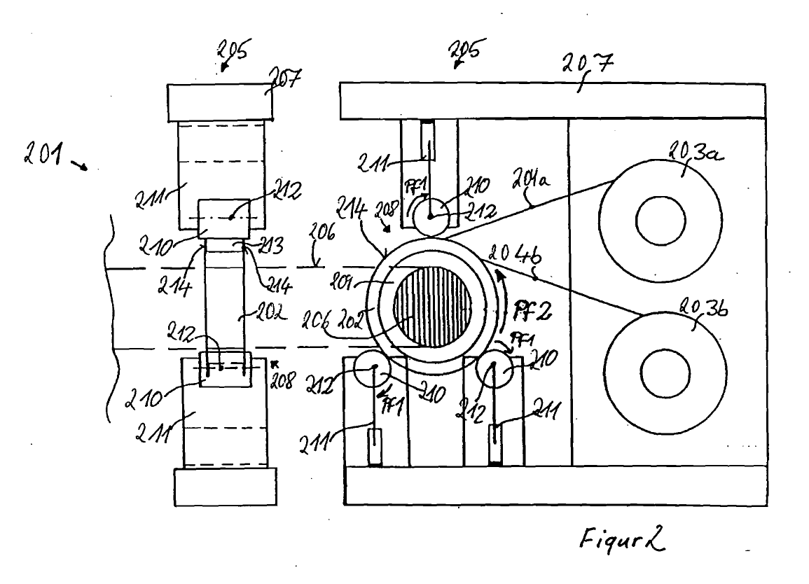

In FIG. 2, a winding device designated as a whole with 201 for wrapping winding carriers 202 is shown. The winding device for wrapping winding carriers 202 with winding material 204a, 204b stored on rotatably supported winding material storage rollers 203a has two winding stations 205, which are spaced apart from each other by 90 degrees, arranged on a toroidal core 6 shown in outline. The winding stations 205 each have a carrier holder 207, with a holding and rotating support 208, for each winding carrier 202. The winding carriers 202 are each arranged concentric around the toroidal core 206, wherein an air gap 209 remains free between the toroidal core 206 and the winding carriers 202. The toroidal core 206 is held in the shown position with a not-shown holding device.

The holding and rotating supports 208 each have three rollers 210 supported rotatably on a roller holder 211 as roller bodies, which support the winding carrier 202. Two of the rollers 210 support the winding carriers 202 from below and thus form a stable support and the third roller 210 holds the winding carrier 202 from above, so that the winding carrier 202 is practically clamped by the three rollers 210 and unintentional detachment of the winding carrier 202 from the holding and rotating support 208 is prevented. The rollers 210 are connected to a driving and braking device, which is not shown and with which the rollers are rotated in the direction of the arrows. Between the rollers 210 and the winding carrier 202 there is a frictionally engaged driving and braking device, so that when the rollers 210 rotate in the clockwise direction, the winding carrier 202 rotates at the same time in the opposite direction. By rotating the winding carrier 202, the winding material 204a, 204b is unwound from the rotatably supported winding material storage rollers 203a, 203b and wound onto the winding carrier 202. Here, the winding carriers 202 can be wrapped simultaneously by the individual winding stations 205.

The winding carriers 202 are comprised of a high-strength insulating material and each have a spool-like construction with the winding space 213 and flanges 214 bounding the sides. The insulating material is necessary for electric resistance, especially relative to the low-voltage winding. The high strength is necessary for the winding process as well as for holding the relatively heavy winding material. The outer edges of these side flanges 214 are used as load surfaces for the rollers 210. The winding material 204a, 204b can be guided between the side flanges 214 onto the winding carrier 202 without obstructing the feed of the winding material 204a, 204b through the rollers 210. In addition, the side flanges 214 form insulation relative to the adjacent winding carrier and also side boundaries for the winding material 204a, 204b.

The rollers 210 are each spring mounted and damped on their roller holder 211. Therefore, the rollers 210 can allow a holding and rotating support 208 to be opened, in order to allow a winding carrier 202 to be inserted into and removed again from the holding and rotating support. In addition, it is possible to wrap winding carriers of different sizes.

On each winding station 205 there is a first winding material storage roller 203a with conductive material 204a and also a second winding material storage roller 203b with insulating material 204b, for the simultaneous, layered winding of the conductive and insulating material one above the other onto a winding carrier 202.

The invention relates to a high-voltage winding of a toroidal-core transformer and also to its production method for distribution transformers on the basis of toroidal-core technology.

The winding station is provided with a winding carrier comprising two load-stable half shells with side flanges made from insulating material of high strength, which are joined into a load-stable round unit around the closed toroidal core, for accommodating the segments of the high-voltage winding of the transformer comprising at least one electrical conductor and at least one insulating material with a holding and rotating support attaching to the winding carrier for rotatable support of the winding carrier, so that the electrical conductor and the insulating material can be wound onto a closed toroidal core.

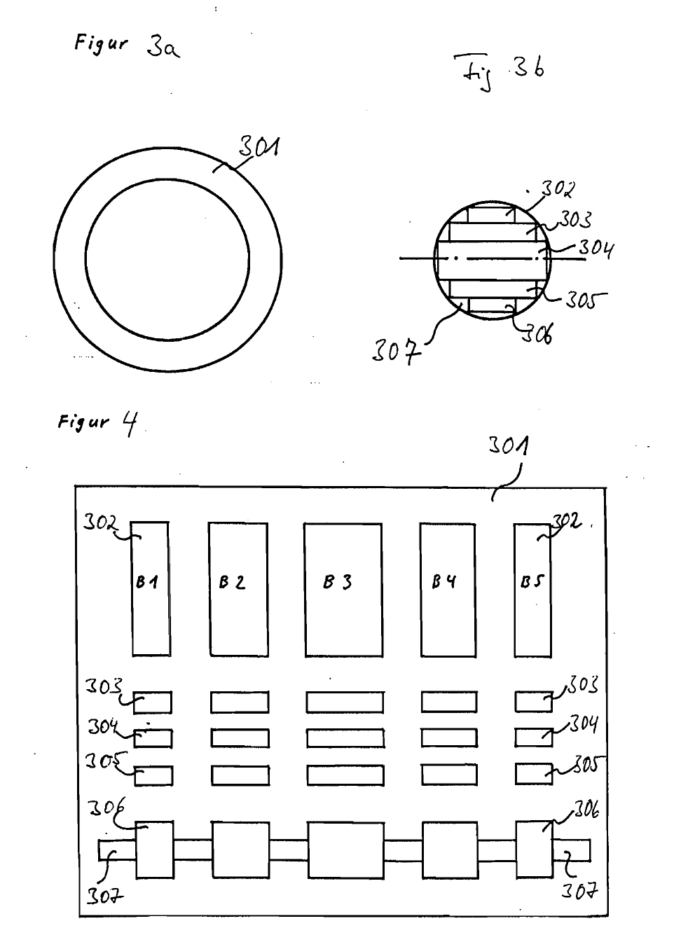

FIGS. 3a and b show a closed toroidal core 301, which is constructed with five stages 302, 303, 304, 305, and 306. The stages are preferably produced with an approximately round cross section. The greater the number of stages, the higher is the filling ratio with magnetically conductive material. The stages are comprised of thin sheets, which are preferably sprayed with adhesive for insulation and for strength. So that a circular cross section is produced, the toroidal core is cast with a casting resin 307. Another advantage of this casting resin is that sharp edges cannot damage the windings of the transformer.

Sheet width of the storage roller 302: B1 100 mm

Sheet height 0.23 mm

| | |
|---|---|
| B2 | 100 mm + x |
| | (magnetic steel sheet) |
| B3 | 100 mm + x1 |
| B4 | 100 mm + x |
| B5 | 100 mm |

The first sheet width of 100 mm is fed and fixed via the guide device 303 to the winding device 306. The winding process begins and, at the same time, the sheet is sprayed with adhesive using the adhesive device 304. By means of the driving and braking device a uniform tension is achieved on the sheet to be wrapped. A measurement device compares the wound sheet height with the desired value and the winding process is stopped when the set value is reached. Then the sheet is separated and fixed by the cutting device 305.

On the guide rail 307, the winding device 306 of the 2nd sheet width (B2) is now fed. Simultaneously, another winding device is fed the first sheet width. In steady state operation, five toroidal-core transformer cores are wound simultaneously.

1. Toroidal-core transformer, comprising a polyphase transformer (101) with several toroidal cores (102) arranged adjacently in an axial direction, wherein adjacent ones of the toroidal cores (102) carry phase windings of different phases, connection points of the phase windings of two adjacent ones of the toroidal cores (102) are arranged offset relative to each other in a peripheral direction.

2. Transformer according to claim 1, wherein the offset or geometric angle between the connection points of the phase windings of the two adjacent ones of the toroidal cores (102) corresponds to a phase shift or an electric phase angle between voltage signals of the toroidal cores (102).

3. Transformer according to claim 1, wherein a generally cylindrical housing adapted to a structural shape of toroidal-core transformers is provided for the toroidal cores (102) with the phase windings and a fan or a blower is provided at one axial end of the housing.

4. Transformer according to claim 3, wherein hollow lines for a coolant are arranged in an area of the toroidal cores (102) and the housing of the transformer (101) is constructed as a heat exchanger and is connected to the hollow lines.

5. Transformer according to claim 3, wherein cooling bodies or similar projecting elements are provided on an outside on the housing for increasing a surface area of the housing.

6. Transformer according to claim 1, wherein a receptacle container is provided with a coolant for insertion in some or all areas of the transformer (101).

7. Transformer according to claim 1, wherein the toroidal cores (102) of the polyphase transformer (101) have a modular construction with the phase windings and a holding device (104) is provided for holding and for mutual fixing of the modular-type toroidal cores (102).

8. Transformer according to claim 1, wherein the transformer coils are cast individually with casting resin and have an outer profiling for increasing a surface area.

9. Transformer according to claim 1, further comprising a winding carrier (202) having at least one side flange (214) with an insulated hollow space, and at a bottom end of the hollow space there is an opening for passage of a start of the underlying winding of conductive material of a high-voltage winding which extends upwards into a winding space of the winding carrier (202).

10. Transformer according to claim 9, wherein the winding carrier (202) is comprised of at least two parts with two of the side flanges (214), and the parts have at least one overlapping latching device or a hinge and an overlapping latching device.

11. Transformer according to claim 10, wherein the at least two parts of the winding carrier (202) are joined together to form a round unit.

12. Transformer according to claim 9, wherein the winding carrier (202) is comprised of several insulating materials, the winding carrier (202) has holders for a high-voltage winding, the at least one side flange comprises side flanges (214) of the winding carrier (202) which possess a frictionally engaged and/or positive-fit surface, the winding carrier (202) has spacers for setting a defined spacing of segments, and the winding carrier (202) has holders for setting a defined spacing to a low-voltage winding.

13. Transformer according to claim 9, wherein the winding carrier (202) is filled with a casting resin, a casting resin filler, or gaseous or liquid insulating materials.

14. Transformer according to claim 9, wherein the winding carrier (202) has an electrically conductive construction on an outside thereof.

15. Device for producing a toroidal core polyphase transformer, comprising: at least one winding station (205) provided with a holding and rotating support (208) for the rotatable support of a winding carrier (202) of the transformer, the holding and rotating support (208) includes several rollers (210) or cylindrical bodies, which contact the winding carrier (202) on a peripheral side thereof and of which at least one is connected to a driving and braking device, in order to drive and to brake the winding carrier (202), so that an electrical conductor can be wound with an insulating material onto a closed toroidal core (206).

16. Device for producing a transformer according to claim 15, wherein for simultaneous wrapping of several of the winding carriers (202) there are several of the winding stations (205) arranged one next to the other in a peripheral direction.

17. Device for producing a transformer according to claim 15, wherein at least one winding material storage roller (203a) with the conductive material (204a) and at least one second winding material storage roller (203b) with the insulating material (204b) are provided for simultaneous, layered winding of conductive material and insulating material onto the winding carrier (202).

18. Device according to claim 17, wherein three, four, or five winding material storage rollers are provided for the simultaneous wrapping of the winding carrier (202) and that two, three, or four of the winding material storage rollers carry the conductive material and the third, fourth, or fifth of the winding material storage rollers carries the insulating material for insulation.

19. Device according to claim 15, wherein cylindrical bodies are provided for supporting the winding carrier (202), wherein the cylindrical bodies are spring-mounted and or supported with damping for adapting to a diameter and/or outline of different ones of the winding carriers (202).

20. Device for producing a toroidal core for a transformer according to claim 15, wherein a carrier frame is provided with at least three storage roller devices for magnetically conductive material in at least two different widths, each with a braking device, at least three adhesive spraying devices, at least three winding devices with a drive system, at least three guide devices, a guide rail, and a cutting device.

21. Device according to claim 20, wherein each of the storage roller devices and also each of the winding devices is equipped with a driving and braking device.

22. Device according to claim 20, wherein two of the winding devices are provided each with a driving and braking device for each width of the magnetically conductive material with the exception of a widest material.

23. Method for producing a toroidal core polyphase transformer, comprising: arranging toroidal cores in an axial direction, with adjacent ones of the toroidal cores carrying phase windings of different phases, offsetting connection points of the phase windings of adjacent ones of the toroidal cores in a peripheral direction, and filling a winding carrier (202) solid, liquid, or gaseous insulating material after or during the application of a high-voltage winding.

24. Method for producing a transformer according to claim 23, further comprising placing a separable casting mold around the closed toroidal core (206) for manufacturing the winding carrier (202).

25. Method according to claim 24, wherein the winding carrier (202) is produced using a pressure-gelling method.

26. Method according to claim 24, wherein the winding carrier (202) is wrapped after the casting mold is removed.

27. Method for producing a transformer according to claim 23, wherein the winding carrier (202) is filled with a casting resin under atmospheric conditions, a casting resin filler under a vacuum, a casting resin filler through a pressure-gelling method, or with gaseous or liquid insulating materials as the insulating material during or after the winding process for a tight configuration.

28. Method according to claim 27, wherein nitrogen or an insulating oil is used as the insulating material.

29. Method for producing a toroidal core for a transformer according to claim 23, further comprising winding magnetically conductive material to form the toroidal core, cutting the magnetically conductive material for achieving a desired winding height, and feeding the wound toroidal core to another winding station and further wrapping with magnetically conductive material of a different width.

30. Method according to claim 29, further comprising spraying the magnetically conductive material with adhesive during the winding.
